(19) United States
(12) Patent Application Publication
(10) Pub. No.: US 2002/0104570 A1
(43) Pub. Date: Aug. 8, 2002

(54) CHECK VALVE ASSEMBLY FOR A RECIRCULATION TUBE

(76) Inventors: Daniel Paul Cunkle, Jonesville, MI (US); Stephen Anderson, Livonia, MI (US); Daniel N. Smith, Chelsea, MI (US); Larry Martin Vandervoort, Spring Arbor, MI (US)

Correspondence Address: Douglas W. Sprinkle, Gifford, Krass, Groh, Sprinkle,, Anderson & Citkowski, P.C., 280 N. Old Woodward, Suite 400, Birmingham, MI, 48009, US

(21) Appl. No.: 09/778,549

(22) Filed: Feb. 7, 2001

(51) Int. Cl. F16K 24/04

(52) U.S. Cl. 137/587

(57) ABSTRACT

A check valve assembly is disclosed for use with a fuel vapor recirculation tube in a fuel system for an automotive vehicle. The vapor recirculation tube has a lower end open to the fuel tank and an upper end open to the upper end of the fuel filler pipe. The check valve assembly includes a housing having a throughbore, and the housing is positioned within and fluidly in series with the recirculation tube adjacent the upper end of the recirculation tube. The housing includes a valve seat at its end closest to the filler pipe while a normally open valve is mounted to the housing and movable from an open position to a closed position in response to liquid fuel flow into the upper end of the recirculation tube.

### BACKGROUND OF THE INVENTION

I. Field of the Invention

The present invention relates generally to valve assemblies and, more particularly, to a check valve assembly for use with a recirculation tube in an automotive fuel fill system.

II. Description of the Prior Art

Automotive vehicles, such as cars and trucks, typically have a filler pipe having a lower end open to the fuel tank. The upper end of the filler pipe is typically covered by a fuel cap or equivalent structure. The fuel cap is removed from the filler pipe when refilling of the fuel tank is desired.

Modem day automotive fuel fill systems further include a recirculation tube having a lower end open to the fuel tank and an upper end open to a position closely adjacent the upper end of the filler pipe. During a fuel filling operation, the fuel flow through the filler pipe inducts fuel vapors from the tank up through the recirculation tube and into the fuel flow. Consequently, these fuel vapors become intermixed with the fuel and are returned to the fuel tank rather than simply dispersed to the atmosphere.

These recirculation tubes, furthermore, are open to the fuel vapor recovery system for the automotive vehicle. Such fuel vapor recovery systems are employed to capture fuel vapor from the fuel system and periodically return the fuel vapors to the fuel flow to the engine. When that occurs, the fuel vapors are combusted which is much more desirable than permitting the fuel vapors to escape into and thus pollute the atmosphere.

These fuel vapor recovery systems include many components, such as carbon canisters. Many of these components in the fuel vapor recovery system, and particularly the carbon canister, should be exposed only to vapor fuel since liquid fuel can damage these components of the fuel vapor recovery system.

During a normal fuel filling operation, a fuel nozzle from a gasoline pump is inserted into the upper end of the fuel filler pipe. When the nozzle is open, the fuel flow from the nozzle passes through the fuel filler pipe and into the fuel tank as desired. Simultaneously, fuel vapors are inducted up from the fuel tank, through the recirculation tube and into the fuel flow from the fuel nozzle. When the fuel nozzle experiences back pressure, indicative of a filled tank condition, the fuel nozzle automatically turns off. At this point in a normal fuel filling operation, the fuel level in the fuel tank and in the fuel filler pipe is below the highest point of the recirculation tube so that no liquid fuel flows through the recirculation tube from the fuel filler pipe or nozzle.

However, in some instances the fuel nozzle from the gasoline pump fails so that the fuel nozzle continues to pump fuel into the fuel filler pipe until the gasoline overflows from the top or open upper end of the filler pipe. When this happens, liquid fuel can pass through the fuel recirculation tube thus damaging components of the fuel vapor recovery system.

### SUMMARY OF THE PRESENT INVENTION

The present invention provides a check valve for use with a recirculation tube which prevents the flow of liquid fuel through the recirculation tube in the event of a failed fuel nozzle valve.

In brief, the check valve of the present invention comprises a housing having a throughbore. This housing is positioned within and fluidly in series with the recirculation tube adjacent the upper end of the recirculation tube. Furthermore, the upper end of the recirculation tube generally extends upwardly for a short distance from the fuel filler pipe.

The housing includes a valve seat at its end closest to the filler pipe. Preferably, this valve seat is semispherical in shape although other shapes may be used without deviation from the invention.

A normally open valve is mounted to the housing and is movable from an open position to a closed position in response to liquid fuel flow into the upper end of the recirculation tube. This normally open valve includes a portion which abuts against the valve seat in response to fuel flow into the recirculation tube when the valve is moved to its closed position. In doing so, the valve prevents the flow of liquid fuel through the recirculation tube.

Preferably, the valve includes an elongated stem which extends through the housing throughbore. One or more tabs are secured to the end of the valve stem opposite from the valve seat, and these valve tabs abut against the other end of the valve housing to retain the valve to the valve housing.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is a diagrammatic view illustrating the preferred embodiment of the present invention installed in a vapor recirculation tube;

FIG. 2 is a longitudinal sectional view of the preferred embodiment of the present invention and illustrating the valve in an open position;

FIG. 3 is a view similar to FIG. 2, but illustrating the valve in a closed position;

FIG. 4 is a view taken substantially along line 4-4 in FIG. 2; and

FIG. 5 is a longitudinal sectional view with parts removed and illustrating the assembly of the check valve.

### DETAILED DESCRIPTION OF A PREFERRED

### Embodiment of the Present Invention

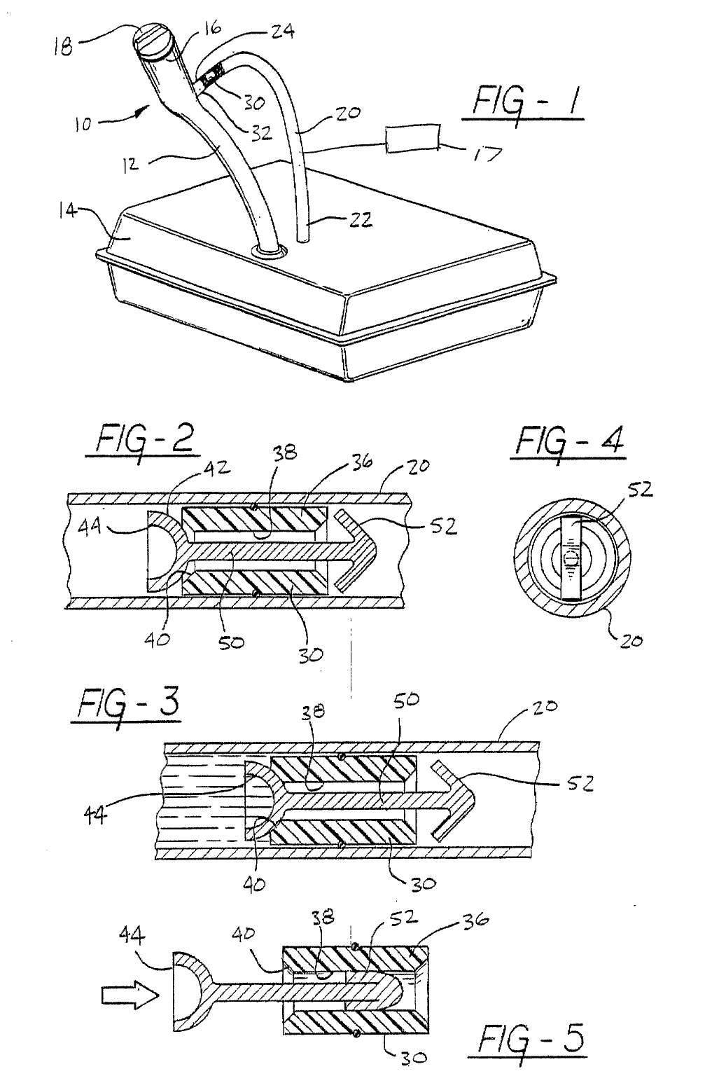

With reference first to FIG. 1, a portion of an automotive fuel fill system 10 is illustrated having a fuel filler pipe 12. The filler pipe 12 is open at its lower end to a fuel tank 14 while an upper end 16 of the filler pipe 12 is typically closed by a gas cap 18 or equivalent structure. In the conventional fashion, in order to fill the fuel tank 14, a nozzle from a gasoline pump is typically inserted into the upper end 16 of the filler pipe and the nozzle is opened. In doing so, the liquid fuel normally flows downwardly through the filler pipe 12 and into the fuel tank 14 in the desired fashion.

Still referring to FIG. 1, a fuel vapor recirculation tube 20 has a lower end 22 open to the fuel tank 14. An upper end 24 of the recirculation tube 20 is open to the filler pipe 12 closely adjacent its upper end 16. The recirculation tube 20 is also connected to the fuel vapor recovery system 17, illustrated only diagrammatically. Thus, during a normal filling operation of the fuel tank 14, fuel vapor from the fuel tank 14 is forced and inducted up through the recirculation tube 20 and back into the filler pipe 12 where the vapors become entrained in the liquid fuel flow through the filler pipe 12.

In order to prevent the flow of liquid fuel through the recirculation tube 20, a check valve assembly 30 is fluidly positioned within and in series with the recirculation tube 20 adjacent the upper end 24 of the recirculation tube 20. Furthermore, the recirculation tube 20 typically comprises an upper section 32 which extends upwardly from the filler pipe 12 and the check valve 30 is preferably positioned within this upwardly extending section 32.

With reference now particularly to FIG. 2, the check valve assembly 30 is there shown in greater detail and comprises a tubular and cylindrical housing 36 having a throughbore 38. The housing 36 is dimensioned so that its outer surface sealingly engages the inner surface of the recirculation tube 20 so that all vapor flow through the housing 36 passes through its throughbore 38. Any conventional means, such as an adhesive or the like, may be used to secure the housing 36 within the recirculation tube 20.

The housing 36, furthermore, includes a valve seat 40 at its end closest to the filler pipe 12. This valve seat 40 is illustrated in the drawing as semispherical in shape although other shapes may be used without deviation from the spirit or scope of the invention.

Referring now to FIGS. 2 and 3, a valve 42 is mounted to the housing 36 and is movable between an open position, illustrated in FIG. 2, and a closed position, illustrated in FIG. 3. The valve 42 includes a semispherical portion 44 which flatly abuts against the valve seat 40 when the valve 42 is in its closed position (FIG. 3) to prevent liquid fuel flow from the filler pipe 12 and downwardly through the recirculation tube 20.

Referring now to FIGS. 2 and 4, the valve 42 further includes an elongated stem 50 which extends through the housing throughbore 38 and at least one, and preferably two, retaining tabs 52 at the end of the valve stem 50 opposite from the semispherical valve portion 44. These retaining tabs 52 thus abut against the end of the valve housing 36 opposite from the valve seat 40 and thus retain the valve 42 to the valve housing 36.

Preferably, the valve portion 42, valve stem 50 and valve retaining tabs 52 are of a one-piece construction and are preferably constructed of a resilient material, such as plastic. The valve retaining tabs 52, furthermore, preferably extend from opposite sides of the valve stem 50 and are skewed rearwardly towards the valve housing 36. Since the valve 42 is constructed of a resilient material, the valve 42 is preferably assembled to the valve housing 36 by inserting the valve 52 through the housing throughbore 38 as illustrated in FIG. 5. In doing so, the retaining tabs 52 collapse against or closely adjacent the valve stem 50 as the retaining tabs 52 pass through the housing throughbore 38. However, once the retaining tabs 52 have completely passed through the housing throughbore 38, the retaining tabs 52, due to their resiliency, return to their original position as illustrated in FIG. 2 thus securing the valve 42 to the valve housing 36 in the desired fashion.

In operation and assuming a failed fuel nozzle condition, liquid fuel initially begins to flow into the upper end of the recirculation tube 20. The liquid fuel, however, contacts the semispherical portion 44 of the valve 42 and, in doing so, moves the valve 42 to its closed position (FIG. 3) thereby preventing the flow of liquid fuel downwardly through the recirculation tube 20. After the liquid fuel is removed from the upper end of the recirculation tube 20, the valve 42 returns to its open condition either through gravity or through the upward flow of fuel vapors through the recirculation tube 20.

From the foregoing, it can be seen that the present invention provides a simple, inexpensive and yet totally effective check valve assembly for a recirculation tube in a fuel fill system for an automobile. Having described my invention, however, many modifications thereto will become apparent to those skilled in the art to which it pertains without deviation from the spirit of the invention as defined by the scope of the appended claims.

I claim:

1. For use with a vapor recirculation tube in a fuel system for an automotive vehicle, said automotive vehicle having a fuel tank, a fuel filler pipe and said recirculation tube having an upper end open to an upper end of the filler pipe and a lower end open to the fuel tank, a check valve assembly comprising:
a housing having a throughbore, said housing being positioned within and fluidly in series with the recirculation tube adjacent the upper end of the recirculation tube,
said housing having a valve seat at its end closest to the filler pipe,
a normally open valve mounted to said housing and movable from an open position to a closed position in response to liquid fuel flow into the upper end of the recirculation tube, wherein said valve includes a portion which abuts against said valve seat when said valve is in said closed position to prevent the flow of liquid fuel through the recirculation tube.

2. The invention as defined in claim 1 wherein said valve seat is semispherical in shape and wherein said valve portion is semispherical in shape.

3. The invention as defined in claim 1 wherein said valve comprises a stem which extends through said housing bore and a retainer tab attached to said stem which abuts against the other end of said valve housing.

4. The invention as defined in claim 3 wherein said valve portion, said valve stem and said valve tab are of a one-piece construction.

5. The invention as defined in claim 3 wherein said valve tab is constructed of a resilient material so that, during insertion of said valve stem and said valve tab through said housing throughbore, said valve tab compresses to a position closely adjacent said valve stem.

6. The invention as defined in claim 3 and further comprising a pair of valve tabs secured to said valve stem, said tabs extending outwardly from said valve stem in opposite directions.

7. The invention as defined in claim 6 wherein said valve tabs extend from a distal end of said valve stem towards said valve housing.

8. The invention as defined in claim 1 wherein the recirculation tube includes a section which extends upwardly from the filler pipe and wherein said housing is positioned in said section of said refiner pipe.
